(19) United States
(12) Patent Application Publication
(10) Pub. No.: US 2011/0305932 A1
(43) Pub. Date: Dec. 15, 2011

(54) Heat transfer layered electrodes

(76) Inventor: Tulsee Satish Doshi, Portland, OR (US)

(21) Appl. No.: 12/928,096

(22) Filed: Dec. 3, 2010

Related U.S. Application Data
(63) Continuation-in-part of application No. 11/657,906, filed on Jan. 24, 2007.
(60) Provisional application No. 60/762,430, filed on Jan. 25, 2006.

(51) Int. Cl. H01M 10/50; H01M 2/30; H01M 4/44; H01M 4/00; H01M 4/58; H01M 2/14; H01M 2/06

(52) U.S. Cl. 429/94; 429/120

(57) ABSTRACT

A lithium secondary battery includes at least one thermal energy transfer element having a heat transfer plate and a heat transfer member. In addition, the battery includes a first electrode plate and a second electrode plate, and a first separator and a second separator. The first separator and second separators are located between the first and second electrode plates, and the heat transfer plate is located between the first separator and second separators. The electrode plates, separators, and the heat transfer plate are provided within a cell container. In one embodiment, at least part of the heat transfer member is located on the exterior of the cell container.

### CROSS-REFERENCE TO RELATED APPLICATIONS

This application is a continuation-in-part of U.S. patent application Ser. No. 11/657,906, entitled “METHOD AND APPARATUS FOR THERMAL ENERGY TRANSFER,” filed Jan. 24, 2007, which claims the benefit of U.S. Provisional Patent Application Ser. No. 60/762,430, entitled “USING HEAT SINKS INSIDE A BATTERY TO EXTEND BATTERY LIFE,” filed Jan. 25, 2006. Both applications are hereby incorporated herein by reference in their entirety.

### FIELD OF INVENTION

The field of invention relates to batteries, and more particularly to methods and apparatus for transferring thermal energy to and from a battery.

### BACKGROUND

The electric current that a battery produces is the result of an electrochemical, oxidation-reduction reaction. Generally, this reaction is exothermic, i.e., it produces thermal energy or heat as well as an electric potential between the battery's electrodes. Heat in a battery is also produced as a result of current flowing in the electrodes and terminals.

It is important that a battery be stored and operated within a temperature range prescribed for the particular battery chemistry. The reaction rate in a battery depends upon, among other things, temperature. Generally, the higher the temperature of the reactants, the faster the reaction will proceed. A battery stored or operated at high temperatures will have reduced storage or operating lifetimes. Further, a battery operated in a high temperature environment will have a lower voltage across its terminals than one operated within the prescribed temperature range. In addition, a battery operated at temperatures below the prescribed temperature range will produce less current and reach a state of discharge more quickly than a battery operated in the specified temperature environment. Not only is it important that a battery be stored and operated within the prescribed temperature range, it is also important to maintain the battery within the recommended temperatures when recharging the battery.

Accordingly, there is a need for methods and apparatus for transferring thermal energy to and from a battery to maintain the temperature of the battery within a temperature range prescribed for the particular battery chemistry during storage, use, and recharging operations.

### SUMMARY

One embodiment is directed to a lithium secondary battery. The battery includes at least one thermal energy transfer element having a heat transfer plate and a heat transfer member. In addition, the battery includes a first electrode plate and a second electrode plate, and a first separator and a second separator. The first separator and second separators are located between the first and second electrode plates, and the heat transfer plate is located between the first separator and second separators. The electrode plates, separators, and the heat transfer plate are provided within a cell container. In one embodiment, at least part of the heat transfer member is located on the exterior of the cell container.

Another embodiment is directed to an electrode assembly. A first and second electrode plates and first and second separators are included in the electrode assembly. In addition, the electrode assembly includes a thermal energy transfer element having a heat transfer plate and a heat transfer member. The first separator and second separators are located between the first and second electrode plates. The heat transfer plate is located between the first and second separators, The heat transfer member is located outside of the first and second separators.

Yet another embodiment is directed to a battery that includes at least one thermal energy transfer element having a heat transfer plate and a heat transfer member. In addition, the battery includes a first and second electrode plates, first and second separators. The first separator and second separators are located between the first and second electrode plates. The heat transfer plate is located between the first separator and second separators. The battery additionally includes first and second terminals, and a cell container to contain the electrodes, separators, and heat transfer plate. The cell container includes a can, a top cap, and a bottom cap. The first terminal is positioned in the top cap and the second terminal is positioned in the bottom cap. At least part of the heat transfer member is located on the exterior of the cell container. The can may be a plastic material. The battery may have different battery chemistries. In one embodiment, the battery has lithium-ion chemistry.

### BRIEF DESCRIPTION OF THE DRAWINGS

FIG. 1 is a side view of an exemplary battery according to one embodiment.

FIG. 2 is a top view of the exemplary battery of FIG. 1.

FIG. 3 is a side view of an exemplary heat transfer element.

FIG. 4 is a sectional view of the exemplary battery of FIG. 1 taken along a line 2-2.

FIG. 5 is a sectional view of the exemplary battery of FIG. 1 taken along a line 4-4.

FIG. 6 is a cut-away, perspective view of an exemplary battery according to an alternative embodiment.

FIG. 7A is a cut-away side view of an exemplary battery that includes a thermal energy transfer element according to an alternative embodiment and FIG. 7B is a perspective view of the element. FIG. 7C is a cross-sectional view of an exemplary electrode assembly including the thermal energy transfer element of FIG. 7A.

FIG. 8A is a left-side plan view and FIG. 8B is a front side plan view of a thermal energy transfer element according to an additional embodiment.

In the drawings and description below, the same reference numbers are used in the drawings and the description to refer to the same or like parts, elements, or steps.

### DETAILED DESCRIPTION

A battery includes one or more cells and each cell comprises an anode, a cathode, and an electrolyte, as well as a container to hold the components. Thermal energy may be transferred between the electrolyte and the external environment via the container and via the battery's terminals. However, there are several disadvantages associated with relying on the container and terminals for heat transfer. First, the cell container is often not an optimum thermal conductor. For example, plastic cell containers dissipate heat poorly. Second, the transfer of thermal energy between the interior of the cell container and the external environment is uneven. Thermal energy near container walls and terminals is transferred more readily than energy located in regions less proximate to walls and terminals.

A first embodiment of the claimed inventions will be described with reference to a lithium-ion battery having an aqueous electrolyte and a separator between planar electrode plates. However, this is for purpose of illustration, as the claimed inventions are not limited to any particular type of battery. An exemplary embodiment is a battery having one or more elements for transferring thermal energy to and from the electrolyte. According to the claimed inventions, the thermal energy transfer elements 134 may be in direct contact with the electrolyte.

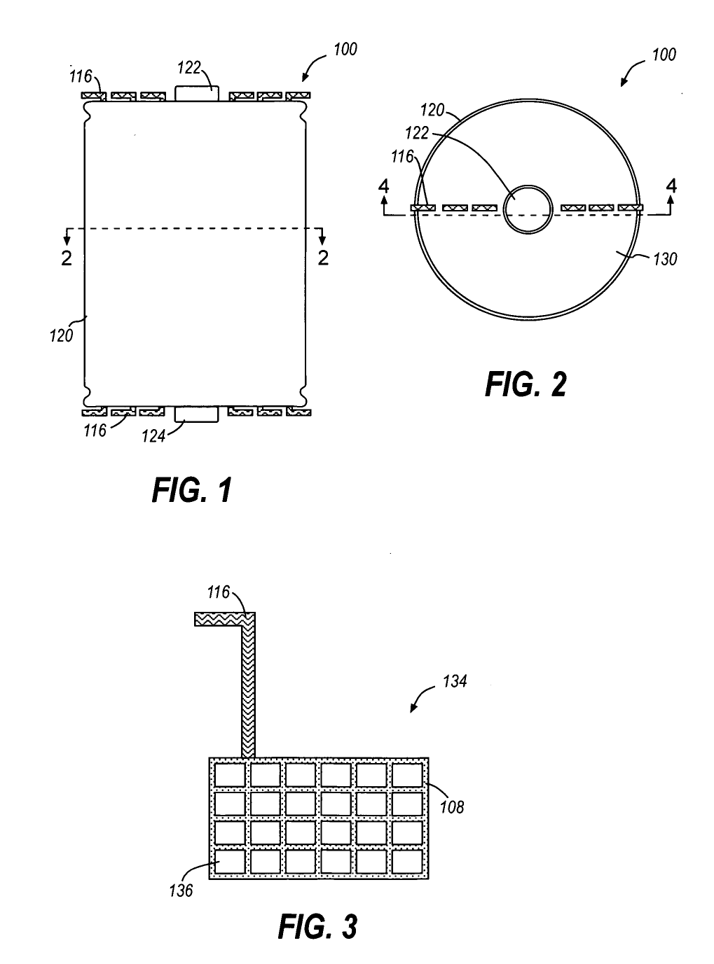

FIG. 1 is a side view and FIG. 2 is a top view of an exemplary battery 100 according to one embodiment. The electrodes of the battery 100 have relatively large surface areas in order to provide high current carrying capacity for a given cell container size. High currents increase heat generation during charging and discharging cycles. As such, the need for removing excess heat from a battery may increase in batteries designed for high current carrying capacity. In addition, it is always desirable to minimize manufacturing costs. In one embodiment, to reduce materials cost, the battery 100 may include a cell container that is made entirely or partially from a plastic material. While plastic materials can be inexpensive and durable, plastic generally dissipates heat poorly and is often flammable. Accordingly, the need for removing excess heat from embodiments of the battery 100 that include a plastic case is particularly acute.

As can be seen from FIGS. 1 and 2, the battery 100 includes a cylindrical can 120, which includes top and bottom caps 130, 132. The can 120 may be made from a plastic material. However, it is not critical that the can be made from plastic. In alternative embodiments, the can 120 may be made from any desired material, e.g., metal, glass, or ceramic. The can 120 functions to contain the electrodes, separators, and electrolyte. Caps 130, 132 function to seal the top and bottom of the can 120, and the can and caps collectively may be referred to as a cell container. The battery 100 includes a positive terminal 122 and a negative terminal 124. The terminals 122, 124 may be any suitable electrically conductive material, such as metal, in any desired shape or size, though the terminal size should be large enough to handle peak electrical currents. In addition, the battery 100 includes one or more thermal energy transfer elements 134.

FIG. 3 is a side view of an exemplary heat transfer element 134. The heat transfer element 134 includes a heat transfer plate 108 and a heat transfer member 116. As can be seen from FIG. 3, the heat transfer plate 108 may be a mesh or grid formed in the shape of a sheet. While the heat transfer plate 108 is shown as a flat sheet, it may be sufficiently malleable or flexible so that the flat sheet may be bent into a variety of shapes. In one embodiment, the heat transfer plate 108 may be rolled in a spiral. Alternative shapes may provide a greater surface area of contact with the electrolyte or other advantages. The openings 136 in the heat transfer plate 108 allow ions to pass through the plate, thereby minimally interfering with the electrochemical reaction, while at the same time providing a spatially distributed surface for transferring thermal energy. The openings 136 may be any desired size or shape, e.g., rectangular or circular.

The heat transfer plate 108 may be formed from any material capable of conducting a sufficient amount of thermal energy to help keep the temperature of the cell within a temperature range prescribed for the particular battery chemistry during storage, use, and recharging operations. In addition, in some embodiments, the heat transfer plate 108 may be formed of a material that does not react with the electrolyte or otherwise interfere with the electrochemical reaction inside the cell container. Further, the heat transfer plate 108 may have a melting point sufficiently above the maximum expected internal temperature of the battery. Moreover, the material from which the heat transfer plate 108 is formed is preferably a poor electrical conductor, however, this is not essential in every embodiment. As an example, the heat transfer plate 108 may be a ceramic containing silicon carbide or silicon nitride. For instance, silicon carbide has high thermal conductivity, a high melting point, is chemically inert, and is a poor electrical conductor. As another example, the heat transfer plate 108 may be formed from a suitable composite material, such as a composite that contains oriented pyrolytic graphite suspended in a polymer composition, such as a thermosetting resin, which is chemically inert with respect to the particular electrolyte. One of ordinary skill in the art will be aware of other suitable materials.

In some embodiments, the heat transfer plate 108 may be surrounded with an envelope, or coated with a particular material. In other embodiments, the heat transfer plate 108 is not surrounded with an envelope, or coated with a particular material. The envelope or coating serves to prevent the heat transfer plate 108 from reacting with the electrolyte or interfering with the electrochemical reaction inside the cell container. The envelope or coating material should have a melting point sufficiently above the maximum expected internal temperature of the battery. Where an envelope or coating material is employed, it is not essential that the material from which the heat transfer plate 108 is made be inert with respect to the reaction. Nor is it essential that the envelope or coating material be a poor electrical conductor, though this is preferred. For example, the heat transfer plate 108 may be made from sheets of flexible metal, such as copper or aluminum sheets. One of ordinary skill in the art will be aware of other suitable materials.

The envelope or coating may be made from any material that is inert with respect to the chemical reaction in the cell and that has a melting point sufficiently above the maximum expected internal temperature of the battery. In addition, the material may function as an electrical insulator, though this is not essential. In some embodiments, the material may be a poor thermal insulator. The envelope or coating may be made relatively thin in order to provide relatively good overall thermal conductivity. For example, an envelope or coating of a polyethylene may be used. Polyethylene, such as VLPDE (very low density polyethylene), is one preferred coating material because it has excellent chemical resistance and a melting point above 100° C. As another example, a ceramic material may be used. Magnesium oxide is one example of a ceramic that may be used as a coating material. One of ordinary skill in the art will be aware of other suitable materials. In embodiments where the heat transfer plate 108 is surrounded with an envelope, it may be made from a porous material or a material with openings to permit ions to flow freely between electrodes. For example, an envelope or sheet may have openings that may be aligned with the openings 136. In one embodiment, the openings in the envelope or sheet may be alignable, but may be of a smaller size than the openings 136. However, where the heat transfer plate 108 is coated with a material to prevent the heat transfer plate 108 from reacting with the electrolyte or interfering with the electrochemical reaction, it is not necessary that the material be porous, as the porosity necessary for ion flow is provided by openings in the heat transfer plate 108.

In embodiments where an envelope or coating is used to prevent the heat transfer plate 108 from reacting with the electrolyte or interfering with the electrochemical reaction, the envelope or coating may surround the heat transfer plate 108. The envelope or coating may also surround all or part of the heat transfer member 116. However, it is not essential that the envelope or coating surround all or part of the heat transfer member 116. In one embodiment, a first portion of the heat transfer member 116 may be surrounded by an envelope or coating material and a second portion may be surrounded by the envelope or coating material. For example, the first portion of the heat transfer member 116 may be internal to a cell container while the second portion is external to the cell container. In one embodiment, portions of the heat transfer member 116 that may come into direct contact with the electrolyte may include the envelope or coating, whereas portions of the heat transfer member 116 not expected to come into direct contact with the electrolyte, such as portions that are external to the cell container may not include the envelope or coating. In one embodiment, a separator (e.g., separator 106) in a cell may serve as all or part of an envelope or coating surrounding all or part of the heat transfer member 116.

Referring again to FIG. 3, the heat transfer member 116 may be a bar or rod with an optional portion transverse to the long axis of the bar. The heat transfer member 116 may be rigid or flexible. Further, the heat transfer member 116 may include a rigid portion and a flexible portion. For instance, a portion within the cell container may be a flexible wire while a portion outside of the cell container may be a rigid bar. In addition, the heat transfer member 116 may be made from a material that is the same as or different from the material from which the heat transfer plate 108 is made. In one embodiment, all or part of the heat transfer member 116 is made from a metal, such as copper. For example, a portion of heat transfer member 116 external to the cell container may be copper. The heat transfer member 116 and the heat transfer plate 108 may be formed as a single integral part. Alternatively, the heat transfer member 116 and the heat transfer plate 108 may be separate parts coupled with one another. In one embodiment, the heat transfer member 116 may include two or more portions that are perpendicular to a portion coupled with the heat transfer plate 108. In one embodiment, the heat transfer member 116 may be thermally coupled with one or more heat sinks or heat sources.

Referring again to FIGS. 1 and 2, it can be seen that the figures only show the portions of thermal energy transfer elements 134 external to the cell container 120, i.e., part of heat transfer members 116. Any number of thermal energy transfer elements 134 may be used. In FIG. 1, six heat transfer members 116 are shown on each end of the battery 100. The six heat transfer members 116 are shown as an example, and more or fewer heat transfer members 116 may be provided in alternative embodiments. The terminals 122, 124 and heat transfer members 116 may be mounted in the caps 130, 132.

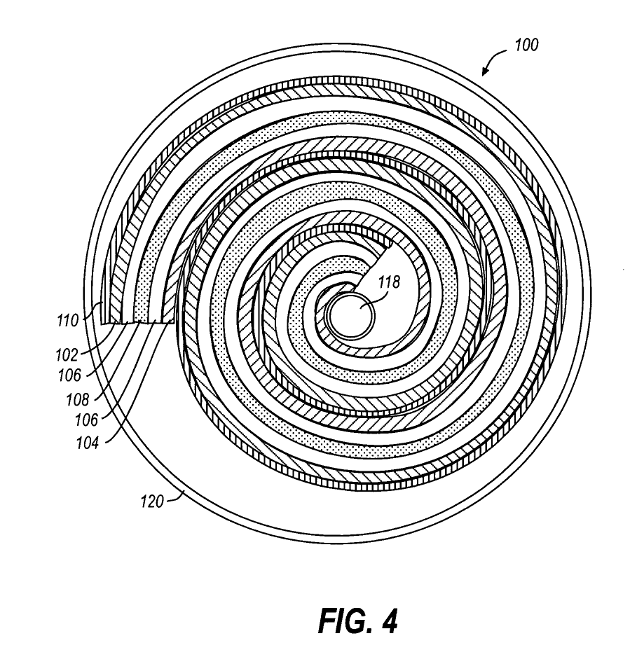

FIG. 4 is a sectional view of the battery 100 taken along a line 2-2. FIG. 4 shows that the battery 100 includes a first electrode plate 102, a second electrode plate 104, two separators 106, a heat transfer plate 108, and an insulator 110. The first and second electrode plates 102, 104, the two separators 106, the heat transfer plate 108, and the insulator 110 may be provided as sheet shaped elements. The sheets of material may be rolled into a spiral around a core 118. The first electrode plate 102 may be disposed between a separator 106 on one side and the insulator 110 on an opposite side. The two sheets of separator 106 are located between first and second electrode plates 102, 104. The first heat transfer plate 108 is located between the two sheets of separator 106. In one embodiment, the battery 100 includes one cell. In alternative embodiments, the battery 100 may include two or more cells.

The first electrode plate 102 may be a positive electrode and the second electrode plate 104 may be a negative electrode. An active electrode material may be coated onto or impregnated into the first and second electrode plates. In one embodiment, the anode may include carbon, the anode may include a metal oxide including lithium, and the electrolyte is a nonaqueous solution including a lithium salt. The separators 106 serve to prevent the first and second electrode plates 102, 104 from coming into contact. The separators 106 are porous and readily permit the passage of ions. The separators 106 are preferably as thin as possible and it should be recognized that the separators 106 shown in the figures are relatively thick for clarity of illustration only. The separator may be any fiberglass cloth or flexible plastic film known in the art for use as a separator. An electrolytic solution (not shown) may be introduced into the cell container. The electrolytic solution may be a non-aqueous type organic electrolytic solution. The type of the electrolytic solution material is not limited. In addition, in one embodiment, the electrolyte may be solid polymer. For example, a solid polymer film situated between the electrodes. In one embodiment, the electrode plates 102, 104 and electrolyte together form a lithium-ion cell. In alternative embodiments, the electrode plates 102, 104 and electrolyte may form a lithium-polymer cell, a nickel-metal hydride cell, a nickel-cadmium cell, or a lead-acid cell. The particular battery chemistry is not critical. The electrode plates 102, 104 and electrolyte may form a cell based on any desired chemistry. In addition, the battery 100 may be of either the primary or secondary type.

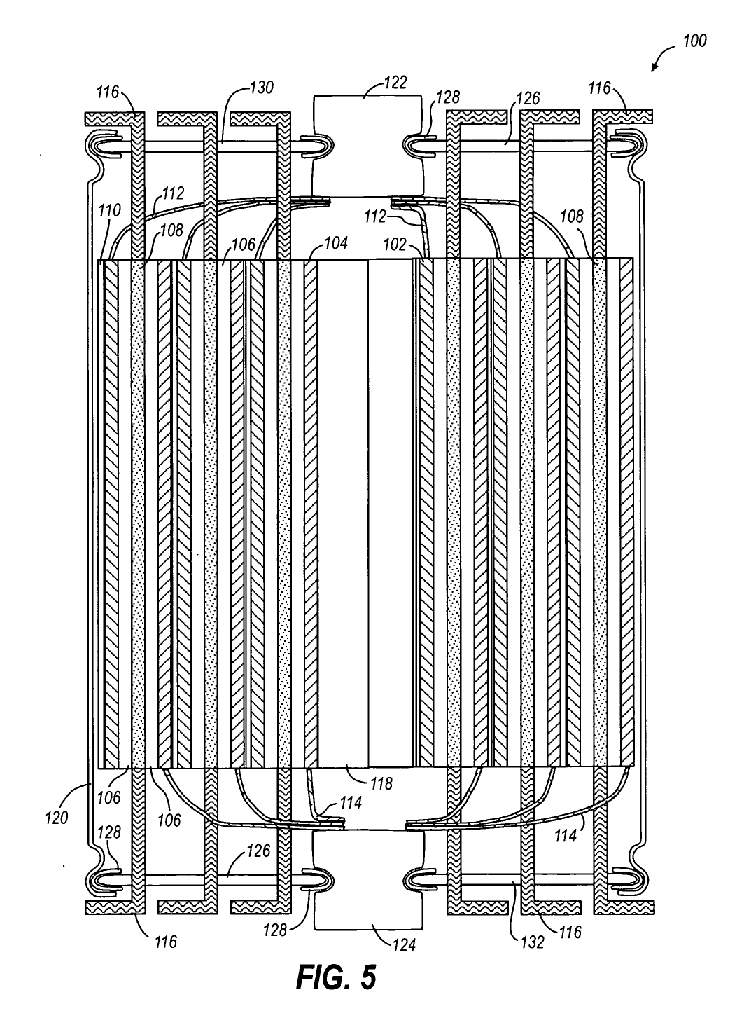

FIG. 5 is a sectional view of the battery 100 taken along a line 4-4. The first electrode plate 102 may be electrically coupled with terminal 122 by one or more first collectors 112, and the second electrode plate 104 may be electrically coupled with terminal 124 by one or more second collectors 114. The insulator 110 may block both the flow of electric current and ions. The insulator 110 may serve to insulate the electrode plates from the walls of the can 120. In one embodiment, the insulator 110 may be omitted. In another embodiment, the insulator 110 may be omitted from the layered spiral, but included between the outside of the spiral and the inside of the can 120. In addition, in one embodiment, the can 120 or caps 130, 132 or both may be provided with a liner to insulate the electrode plates from the can or caps. Sealing members 128 may be provided at the interfaces where the caps 130, 132 join with the can 120 and terminals 122, 124. The sealing members 128 electrically insulate the terminals 122, 124 from the cell container. Additional sealing members (not shown) may be provided at the interface where the heat transfer members 116 pass through the caps 130, 132. The sealing members 128 provide a barrier to prevent or minimize leakage of liquids or gases from the cell container. The battery 100 includes electrolyte (not shown). The electrolyte is at least between the first and second electrode plates 102, 104, e.g., absorbed into the separators 106.

An advantage of the claimed inventions can be seen from FIGS. 4 and 5. The heat transfer plate 108 is in direct contact with electrolyte between the electrodes throughout the interior of the cell container. Thus, thermal energy may be readily transferred to or from central regions of the cell container. The claimed inventions may prevent or minimize “hot spots” within the cell container. In addition, the claimed inventions may provide effective thermal transfer notwithstanding the use of a cell case made of material with poor thermal transmission characteristics, such as plastic. Moreover, the claimed inventions may prevent a cell case made from a flammable material, such as plastic, from exceeding a safe temperature.

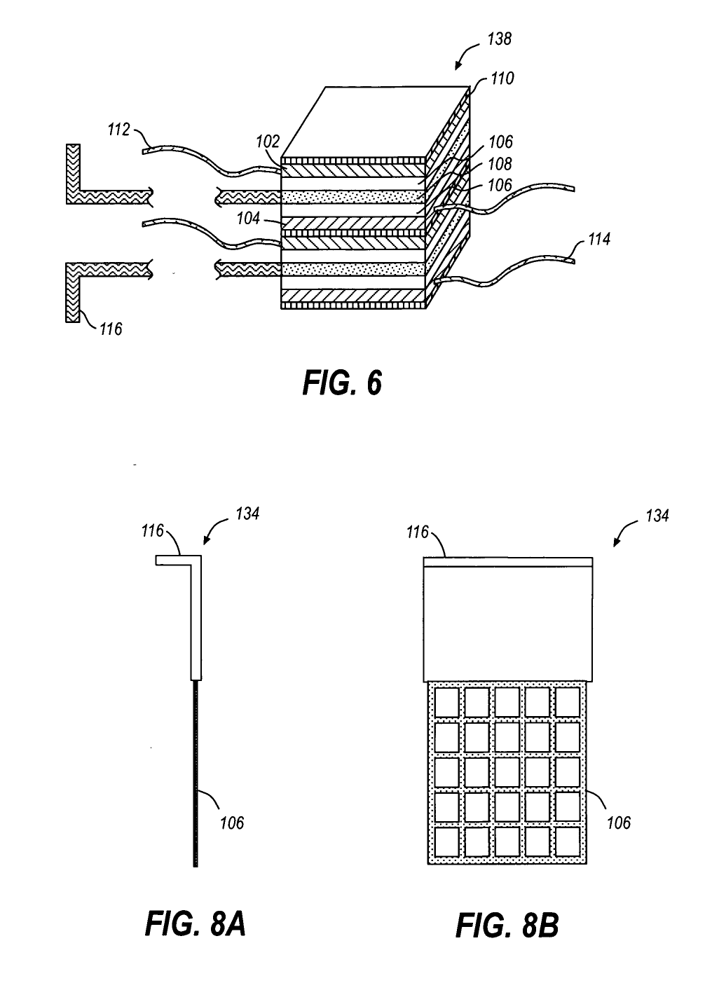

FIG. 6 is a cut-away, perspective view of an exemplary electrode assembly 138 according to an alternative embodiment. The embodiment shown in FIG. 6 is similar to that shown in FIGS. 4 and 5, except that FIG. 6 shows a planar, stacked construction of the electrode assembly 138. The planar electrode assembly 138 includes the first electrode plate 102, second electrode plate 104, pairs of separators 106, and a heat transfer plate 108. The stacked electrode assembly 138 may include an insulator 110 between cells, however, this is not essential. In the shown embodiment, a cell includes first and second electrode plates 102, 104, two separators 106, and a first heat transfer plate 108. The two sheets of separator 106 are located between first and second electrode plates 102, 104. The first heat transfer plate 108 is located between the two sheets of separator 106. While the example shown in FIG. 6 includes two cells, any number of cells may be layered. The layered construction shown in FIG. 6 may be used with any known prismatic or rectangular cell container or with any known pouch (lipo cell) cell container.

In one embodiment, the layered electrode assembly shown in FIG. 6 may be wound around a flat mandrel into a flattened spiral shape for insertion into a prismatic cell container.

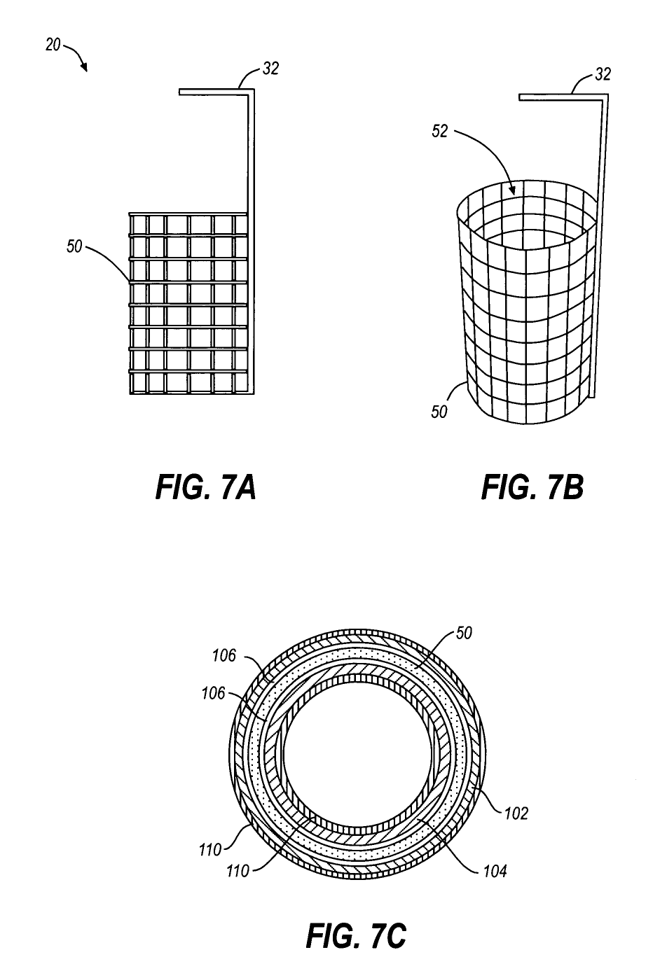

FIG. 7A is a side view of a thermal energy transfer element 134 according to one embodiment and FIG. 7B is a perspective view of the element 134. In this alternative, the heat transfer plate 108 is rolled to form a cylindrical mesh structure 50 and the heat transfer member 116 extends the length of one dimension of the heat transfer plate 50. The cylindrical mesh structure 50 includes an aperture 52 in the center. As shown in FIG. 7C, a first sheet of separator 106 may be wound around the outside of the cylindrical heat transfer plate. A second sheet of separator 106 may be wound around the inside of the cylindrical heat transfer plate 50. A first electrode plate 102 may be wound around the first sheet of separator 106 and a second electrode plate 104 may be wound inside the second sheet of separator 106. In addition, a first sheet of insulator 110 may be wound around the first electrode plate 102 and a second sheet of insulator 110 second electrode plate 104. A cylindrical heat transfer plate 50 with separators, electrodes, and insulators wound about the interior and exterior may thereby form an electrode assembly. The heat transfer plate 108 may be provided in multiple different widths so that when several plates are rolled into cylindrical mesh structures 50, the cylinders are of different diameters. The diameters may be selected such that when the cylindrical mesh structures 50 are combined with separators, electrodes, and insulators, a first electrode assembly may be placed or nested concentrically within a second having a larger diameter. Two or more electrode assemblies of increasingly smaller diameters may be nested concentrically within one another to form a multi-cell structure for placement inside a cylindrical can 120 together with an electrolyte between the electrodes. The different sized cylindrical mesh structures 50 may be rotated with respect to one another so that the heat transfer members 116 are offset from one another.

FIG. 8A is a left-side plan view and FIG. 8B is a front side plan view of a thermal energy transfer element 134 according to an alternative embodiment. In this alternative, the heat transfer plate 108 forms a rectangular a mesh or grid that is coupled with a sheet-shaped heat transfer member 116. The shown planar heat transfer plate 108 may be placed parallel to one or more planar or rectangular-shaped electrodes with a sheet of separator interposed between the heat transfer plate 108 and the electrode.

The claimed inventions may be used with any type of battery, including but not limited to: dry and wet cell batteries, primary batteries, and rechargeable batteries. The claimed inventions may be used with single and multi-cell batteries. Further, the claimed inventions may be used with any type of battery chemistry, including, but not limited to, lithium ion, and nickel metal hydride chemistries. The claimed inventions may be used with batteries having an electrolyte of any type, including liquid, paste, or solid.

As described above, the transfer element 134 may be provided in a variety of shapes. In alternative embodiments, it was said above that at least a heat transfer member 116 may be coupled with a heat transfer plate 108. It should be appreciated that the use of the term “couple” is in intended in its broadest possible sense. The term is intended to include not only gluing, welding, soldering, screwing, riveting, and other conventional means of attachment, but also to include forming the first and third portions as an integral unit, such as where they are formed from a single mold or machined from a single piece of starting material.

In this document, particular structures, processes, and operations well known to the person of ordinary skill in the art may not have be described in detail in order to not obscure the description. As such, embodiments of the claimed inventions may be practiced even though such details are not described. On the other hand, certain structures, processes, and operations may have be described in some detail even though such details may be well known to the person of ordinary skill in the art. This may be done, for example, for the benefit of the reader who may not be a person of ordinary skill in the art. Accordingly, embodiments of the claimed inventions may be practiced without some or all of the specific details that are described.

In this document, references may have been made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A lithium secondary battery, comprising:
at least one thermal energy transfer element having a heat transfer plate and a heat transfer member;
a first electrode plate and a second electrode plate;
a first separator and a second separator, wherein the first separator and second separators are located between the first and second electrode plates, and the heat transfer plate is located between the first separator and second separators;
a first terminal and a second terminal; and
a cell container to contain the electrodes, separators, and heat transfer plate, the cell container having a can, a top cap, and a bottom cap, wherein the first terminal is positioned in the top cap and the second terminal is positioned in the bottom cap.

2. The lithium secondary battery of claim 1, wherein at least part of the heat transfer member is located on the exterior of the cell container.

3. The lithium secondary battery of claim 2, wherein the can is prismatically shaped.

4. The lithium secondary battery of claim 1, further comprising a core, wherein the electrodes, separators, and heat transfer plate are rolled in a spiral around the core.

5. The lithium secondary battery of claim 2, wherein the can is cylindrically shaped.

6. The lithium secondary battery of claim 2, wherein the can is prismatically shaped and the spiral is a flattened spiral.

7. An electrode assembly, comprising:
a first electrode plate;
a second electrode plate;
a first separator;
a second separator; and
a thermal energy transfer element having a heat transfer plate and a heat transfer member, wherein the first separator and second separators are located between the first and second electrode plates, the heat transfer plate is located between the first and second separators, and the heat transfer member is located outside of the first and second separators.

8. A battery, comprising:
at least one thermal energy transfer element having a heat transfer plate and a heat transfer member;
a first electrode plate and a second electrode plate;
a first separator and a second separator, wherein the first separator and second separators are located between the first and second electrode plates, and the heat transfer plate is located between the first separator and second separators;
a first terminal and a second terminal; and
a cell container to contain the electrodes, separators, and heat transfer plate, the cell container having a can, a top cap, and a bottom cap, wherein the first terminal is positioned in the top cap and the second terminal is positioned in the bottom cap, and at least part of the heat transfer member is located on the exterior of the cell container.

9. The battery of claim 8, wherein the can is a plastic material.

10. The battery of claim 8, wherein the electrode plates and electrolyte form a nickel-metal hydride cell.

11. The battery of claim 10, wherein the can is a plastic material.

12. The battery of claim 8, wherein the electrode plates and electrolyte form a nickel-cadmium cell.

13. The battery of claim 12, wherein the can is a plastic material.

14. The battery of claim 8, wherein the electrode plates and electrolyte form a nickel-lead-acid cell.

15. The battery of claim 14, wherein the can is a plastic material

16. The battery of claim 8, wherein the can is a plastic material and the electrode plates and electrolyte form is a lithium-ion cell.

17. The battery of claim 8, wherein the can is a plastic material and the electrode plates and electrolyte form is a lithium-polymer cell.
